(19) United States
(12) Patent Application Publication
(10) Pub. No.: US 2024/0363939 A1
(43) Pub. Date: Oct. 31, 2024

(54) STORAGE SYSTEM CONFIGURED FOR USE WITH AN ENERGY MANAGEMENT SYSTEM

(71) Applicant: Enphase Energy, Inc., Petaluma, CA (US)

(72) Inventors: Santhosh Nerlige SUNDARRAJ, Bangalore (IN); Sharath S, Bangalore (IN); Christie THOMAS, Pathanamthitta (IN); Nellaiappan SIVANPANDIAN, Bangalore (IN); Ravichandran SANKARANARAYANAN, Bangalore (IN); Abhiram MINNIKANTI VENKATA, Electronic city-II (IN); Zhen Alex HUANG, Pflugerville, TX (US); Christopher McNair LYKE, Austin, TX (US); Richard TORRES, Rohnert Park, CA (US); Zhiwei WU, Round Rock, TX (US); Vikram Nandakumar IYENGAR, Austin, TX (US); Chris Morrow YOUNG, Round Rock, TX (US); David Garrett STANTON, Austin, TX (US)

(21) Appl. No.: 18/645,826

(22) Filed: Apr. 25, 2024

(30) Foreign Application Priority Data
Apr. 28, 2023 (IN) 202311030805

(51) Int. Cl. H01M 50/224; H01M 50/251; H01M 50/691; H02J 7/00

(52) U.S. Cl. CPC H01M 50/224; H01M 50/251; H01M 50/691; H02J 7/0063; H02J 2207/20

(57) ABSTRACT

A storage system configured for use with an energy management system is provided. For example, a storage system comprises a battery; a microinverter coupled to the battery; and a chassis comprising a metal backing plate and at least one of an outer metal barrier or an inner metal barrier connected to a metal backing plate, the chassis configured to house the battery and the microinverter in an assembled configuration.

### CROSS-REFERENCE TO RELATED APPLICATIONS

This application claims the benefit of and priority to Indian Provisional Patent Application Serial No. 2023/11030805, filed Apr. 28, 2023, the entire contents of which is incorporated herein by reference.

### BACKGROUND

### 1. Field of the Disclosure

Embodiments of the present disclosure generally relate to power systems and, for example, to improved chassis enclosure for storage systems.

### 2. Description of the Related Art

A grid-tied solar photovoltaic (PV) system is a solar energy system that is connected (or tied) to a utility electrical grid and operates if the grid is available. During a power outage, the grid-tied PV system stops generating power, and remains shut down until the grid power become available. Grid-tied solar photovoltaic (PV) systems can include at least one of a storage system, a smart switch, a combiner, one or more photovoltaics (PVs), and a tertiary control.

The storage system is, typically, housed in a chassis, which can be made from plastic. Under certain conditions, the chassis can be damaged (e.g., can melt) due to thermal runaway. Thermal runaway is a dynamic action that can occur when one or more battery cells of the storage system overheat and cause one or more of the other battery cells to overheat. Additionally, accumulated hot mass mixed by electrolyte and plastic at a bottom of the chassis can easily catch fire and cause additional damage to the storage system. Moreover, a lack of buffer material behind the chassis' backplate can also cause wall temperature to surpass the required wall temperature limits.

Therefore, the inventors describe herein improved chassis enclosure for storage systems.

### SUMMARY

In accordance with at least some aspects of the present disclosure, a storage system configured for use with an energy management system comprises a battery, a microinverter coupled to the battery, and a chassis comprising a metal backing plate and an outer metal barrier connected to a rear of the metal backing plate. The chassis is configured to house the battery and the microinverter in an assembled configuration.

In accordance with at least some aspects of the present disclosure, a storage system configured for use with an energy management system comprises a battery, a microinverter coupled to the battery, and a chassis comprising a metal backing plate and an inner metal barrier connected to a front of the metal backing plate. The chassis is configured to house the battery and the microinverter in an assembled configuration.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a diagram of a backup configuration supported by an energy management system, in accordance with at least some embodiments of the present disclosure;

FIG. 2 is a perspective view of a single-phase AC-coupled battery (SP) and a three-phase AC-coupled battery (3P battery) of the energy management system, in accordance with at least some embodiments of the present disclosure;

FIG. 3 is a partial, perspective view of the SP battery including an integrated DC disconnect switch, in accordance with at least some embodiments of the present disclosure;

FIGS. 4A and 4B are front and perspective views, respectively, of a wall mount bracket for the SP battery, in accordance with at least some embodiments of the present disclosure;

FIGS. 5A and 5B are front and perspective views, respectively, of a wall mount bracket for the 3P battery, in accordance with at least some embodiments of the present disclosure;

FIG. 6A is a perspective view of a chassis, in accordance with at least some embodiments of the present disclosure;

FIG. 6B is the indicated area of detail of FIG. 6A, in accordance with at least some embodiments of the present disclosure; and

FIG. 6C is an exploded view of the chassis of FIG. 6A with parts separated, in accordance with at least some embodiments of the present disclosure.

### DETAILED DESCRIPTION

The inventors describe herein improved chassis enclosures for storage systems. For example, in at least some embodiments, a storage system configured for use with an energy management system is provided and comprises a battery, a microinverter coupled to the battery, and a chassis comprising a metal backing plate and at least one of an outer metal barrier or an inner metal barrier connected to a metal backing plate. The chassis is configured to house the battery and the microinverter in an assembled configuration. The storage systems described herein use both metal and metal parts to contain a fire and keep wall temperatures within limits while maintaining an acceptable cost for battery storage systems.

A storage system configured for use with an energy management system, such as the ENSEMBLE® energy management system available from ENPHASE®, is described herein.

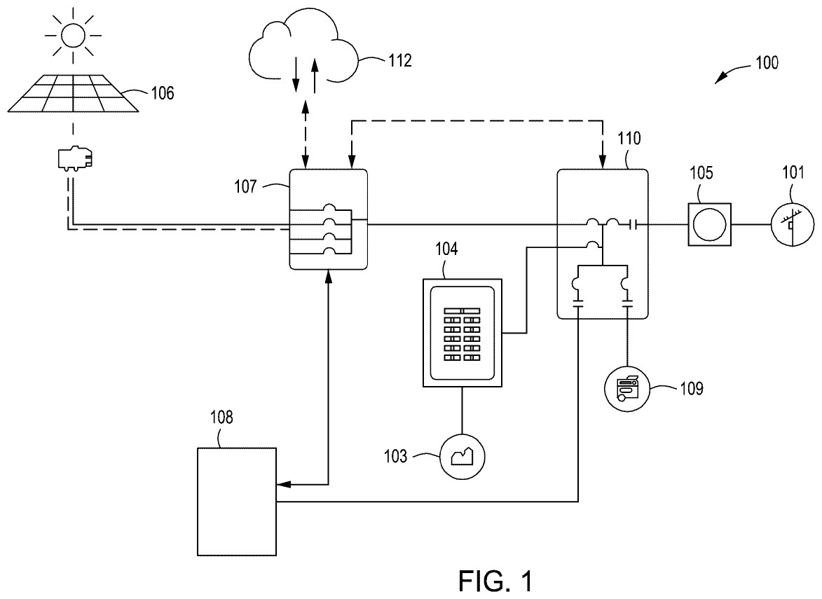

FIG. 1 is a diagram of a backup configuration supported by an energy management system 100, in accordance with at least some embodiments of the present disclosure. The energy management system 100 is compatible with one or more microinverters, both for existing and new installs. The energy management system 100 can be configured for use with backward compatibility with M-or S-Series microinverter systems. In at least some embodiments, the energy management system 100 can be configured to provide a per-panel monitoring feature and real-time monitoring feature.

The energy management system 100 can be provided as a kit. For example, for grid-tied PV only, for grid-tied PV and storage, and/or for a grid-agnostic energy management systems, one or more of the PVs, the SP battery, the 3P battery, the smart switch, the combiner/gateway, Q cable and/or Q accessories can be provided in the kit. Additionally, two main breakers for a supply side and a load side connection of the smart switch, and circuit breakers for connection of PVs and storage systems can also be provided in the kit.

Continuing with FIG. 1, in at least some embodiments, the energy management system 100 comprises a storage system 108, a smart switch 110 (e.g., transfer switch), a combiner 107 including a wireless adaptor, which can be a USB dongle that connects to a communication gateway, PVs 106 (one or more photovoltaics), and a tertiary control 112 (e.g., cloud-based tertiary control using application programming interface (API)), which can provide over-the-air firmware upgrade. The combiner 107 can connect/communicate with the smart switch 110 and the storage system 108 via a wireless connection (or wired connection, such as an AC power wire) and with the Internet and/or cloud via Wi-Fi or cellular connections. For example, the combiner 107 comprises the communication gateway (FIG. 12) to which the wireless adaptor connects and communicates with the smart switch 110, the storage system 108, and the Internet and/or cloud. The combiner 107 connects to the PVs 106 and can communicate with the PVs 106 via a power line communication (PLC) over an AC power wire, and the other components of the energy management system 100 can connect to each other via the AC power wire. A combiner that is suitable for use with the energy management system 100 is the IQ® line of combiners available from Enphase Energy, Inc., from Petaluma, California.

In at least some embodiments, the energy management system 100 of FIG. 1 can be configured as a whole home backup (or partial home backup and subpanel backup) with the smart switch 110 of the energy management system 100 located at a service entrance (e.g., connected to a meter 105 which is connected to a utility grid 101). A user can back up a main load panel 104 (e.g., Siemens MC3010B1200SECW or MC1224B1125SEC, GE 200Amp 20/40, and the like), which connects to one or more loads 103 (e.g., critical or backup loads). In such an embodiment, the smart switch 110 can support up to an 80A breaker for the PVs 106 connected to the combiner 107 (e.g., PV combiner, (solar)) and an 80A breaker for a battery storage circuit (e.g., for the storage system 108). When an existing combiner 107 is connected to the main load panel 104, a user can keep the combiner 107 connected to the main load panel 104, connect only the storage system 108 to the smart switch 110, and the space in the smart switch 110 for the combiner 107 can be left vacant and used for additional battery storage.

The storage system 108 is part of the energy management system 100 and is configured to participate in grid services, such as capacity and demand response. The storage system 108 is durable NEMA type 3R outdoor rated. The storage system 108 is configured as a modular AC-coupled battery storage system with time-of-use (ToU) and backup capability, which allows for easy installation.

The storage system 108 connects to the smart switch 110 and the combiner 107 and is configured to provide backup power when installed in a home or at a site. The storage system 108 includes one or more of a SP battery (120V) or a 3P battery (240V) (e.g., three SP batteries connected to each other, hereinafter 3P battery), which include corresponding internal microinverters, that are connected to (or integrated with) the PVs 106. The storage system 108 can be configured to detect when it is optimal to charge or discharge the SP battery and/or the 3P battery so that energy can be stored therein when energy is abundant and used when scarce.

The storage system 108 is configured to self-protect against low state of charge (e.g., <1%) of battery packs, or cell voltages remaining in extreme low warning region. For example, the storage system 108 is configured to shut down an AC bus and/or DC bus to prevent cell discharge of the SP battery and/or the 3P battery when required.

Additionally, the storage system 108 is configured to send notification alerts via, for example, the combiner 107 to a user. The notification, for example, can be suitable text indicating that the state of charge of the cells of the SP battery or the 3P battery are low, e.g., very low state of charge of the battery cells. Other text can also be used to alert a user. The alerts can also be available to a user and/or a technician or customer service representative to enable proactive appropriate preventive measures to avoid damage to the SP battery and/or the 3P battery. Moreover, the storage system 108 includes suitable energy reserve to self-protect against extremely low state of charge of battery cells of the SP battery and/or the 3P battery due to self-discharge losses of the storage system, e.g., for at least seven days after a notification is sent to a user, technician, and/or customer service representative. In at least some embodiments, the storage system 108 is configured to allow a user to set a remaining state of charge for each day.

FIG. 2 is a diagram of a backside of a SP battery 200 and a 3P battery 202, respectively, in accordance with at least some embodiments of the present disclosure. In at least some embodiments, the SP battery 200 and 3P battery 202 are lithium-ion batteries, such as lithium ferrous phosphate (LFP) batteries, can be configured for passive cooling, can be configured for either indoor and/or outdoor installations, can be configured for wireless communication (e.g., Zigbee, Wi-Fi, Bluetooth, or the like, as described in greater detail below) and can be configured with modular and expandable power and energy rating. The passive cooling feature eliminates the presence of any moving parts (e.g., mechanical fans, coolants, etc.), thereby making the storage system 108 less prone to failures.

The SP battery 200 and 3P battery 202 can be AC-coupled or integrated with the microinverters and can support backup operation and black start. The SP battery 200 has 3.36 kWh capacity and 1.28 kVA rated continuous output power. The 3P battery 202 comprises three SP batteries 200 and has 10.08 kWh and 3.84 kVA rated continuous output power. The modularity allows a user to install as many of the SP battery 200 or 3P battery 202 after an initial installation of the energy management system 100, thus allowing the energy management system 100 to function seamlessly.

The SP battery 200 is configured to connect to one or a plurality of microinverters. For example, in at least some embodiments, the SP battery 200 is configured to connect up to four microinverters 204 which connect to one or more battery cell core pack of the SP battery and which form the grid in a user's house (e.g., a local grid) when a utility grid goes down. Likewise, the 3P battery 202, which is three SP batteries 200, is configured to connect to up to 12 microinverters which also connect to one or more battery cell core pack of the 3P battery and which form the grid in a user's house (e.g., a local grid) when a utility grid goes down. In at least some embodiments, the microinverters 204 are field swappable for both the SP battery 200 and/or the 3P battery 202. That is, the microinverters 204 configured for use with the SP battery 200 are also configured for use with the 3P battery 202. Additionally, in at least some embodiments, the battery cell packs (not shown) for the SP battery 200 are not swappable or configured for use with the 3P battery 202, and vice versa. Alternatively, the battery cell packs for the SP battery 200 can be configured for use with the 3P battery 202, and vice versa. Similarly, a battery controller 113 (FIG. 1), a battery management unit (BMU), and/or AC interface boards (all not shown) are not swappable or configured for use with the 3P battery 202, and vice versa, but in at least some embodiments, they can be.

The SP battery 200 and the 3P battery 202 are configured to respond to a commanded charge or discharge at a given C-rate (e.g., a charge/discharge rate), and accept or receive a predefined hourly, daily, and monthly schedule for charge and discharge at different C-rates. If one microinverter in either of the SP battery 200 or the 3P battery 202 fails (the energy management system 100 has a DPPM value of less-than-1000), the storage system 108 will continue to operate and provide backup with the remaining microinverters; a faulty microinverter can easily be replaced. Additionally, in the 3P battery 202 with 10.08 kWh usable energy capacity, if one SP battery 200 (e.g., one 3.36 kWh) fails, the storage system 108 will continue to operate and provide backup power with its remaining base units.

The SP battery 200 can be used for PV self-consumption, PV non-export, and other grid-tied applications. The SP battery 200 can also be used to augment the 3P battery 202 units in a backup system and provide as many SP batteries required for pairing with PVs beyond the 3P battery limits. Each SP battery 200 can be used to enable backup with relatively small PV systems e.g., of less than 1.9 kWac in size. More SP batteries or 3P batteries can be added for larger PV systems sizes. Up to 1.9 kWac of PV can be supported for backup using each SP battery 200. Up to 5.7 kWac PV can be paired with one 3P battery 202 for backup, and additional batteries can be installed if the size of the paired PV is more than this value.

In addition to the above, the storage system 108 provides backup (Off-grid) capability, e.g., using the SP battery 200 or the 3P battery 202, support backup with seamless transfer (e.g., <100 ms), and provides compatibility with PV module installations. For example, the storage system 108 can be configured for use with new PV installs, retrofits, whole house backup operation up to 200A, sub-panel backup operation up to 200A, grid-tied operation: ToU, self-consumption, and/or daily cycling, and standalone installation without PV modules.

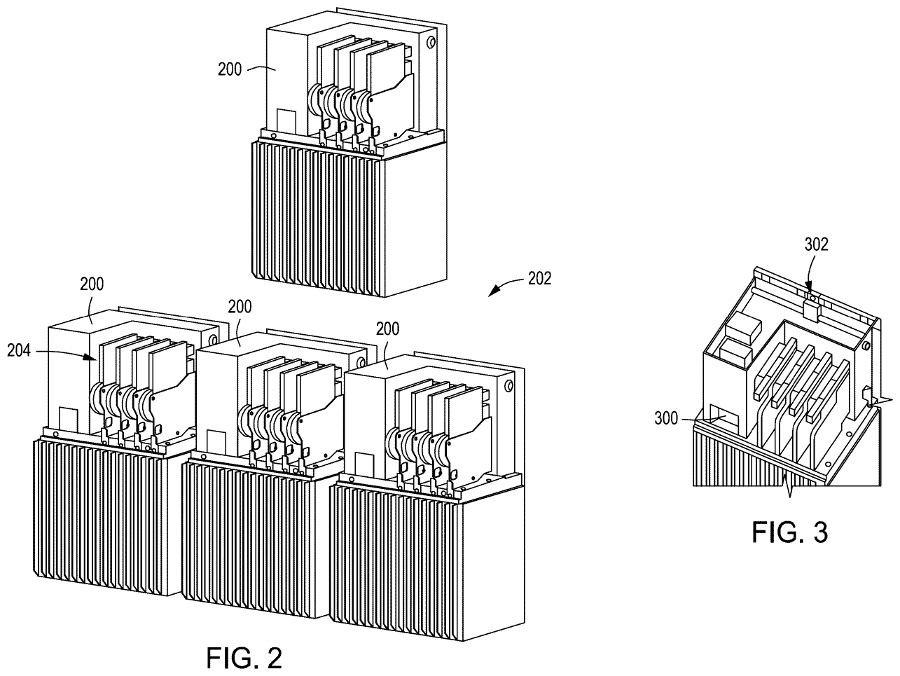

FIG. 3 is a partial, perspective view of the SP battery 200 including an integrated DC disconnect switch 300, which is configured for use with either the SP battery 200 or the 3P battery 202 configuration. In at least some embodiments, during mounting of the SP battery 200 and/or the 3P battery 202, the DC disconnect switch 300 can be in a locked or off configuration to prevent electrical shock, and after the SP battery 200 and/or the 3P battery 202 are installed, the DC disconnect switch 300 can be moved to the unlocked or on configuration.

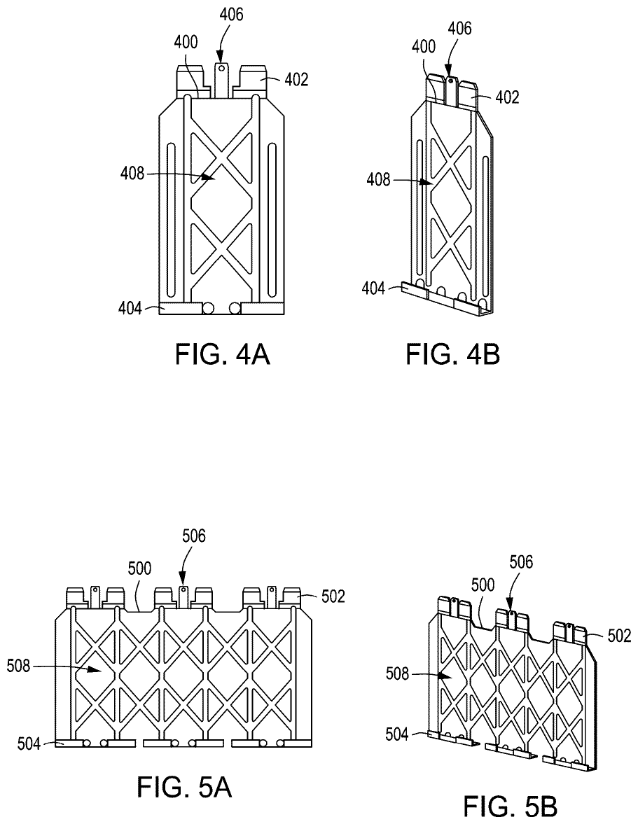

FIGS. 4A and 4B are front and perspective views of a wall-mount bracket 400 for the SP battery. FIGS. 5A and 5B are front and perspective views of a wall-mount bracket 500 for the 3P battery. To mount the SP battery 200 or the 3P battery 202, a user can place them right side up on a flat mounting surface. In at least some embodiments, the SP battery 200 and the 3P battery 202 can be located closest to a main power supply. Next, a user, while supporting the SP battery 200 or the 3P battery 202 from underneath, can lift the SP battery 200 or the 3P battery 202 and hold them at an angle so that a top of the SP battery 200 or the 3P battery 202 sets into a top of a respective the wall-mount bracket 400, 500. Once the top of the SP battery 200 or the 3P battery 202 is engaged with top tabs 402, 502 of the wall-mount bracket 400 and wall-mount bracket 500, a user can maintain the battery relatively vertical, to ensure the SP battery 200 or the 3P battery 202 is flush against their respective wall mount bracket and can lower the SP battery 200 or the 3P battery 202 down until fully seated on a respective wall-mount bracket shelf 404, 504. Next, a user can attach the SP battery 200 or the 3P battery 202 to the mounting bracket by aligning a screw hole 302 (FIG. 3) at a top of the SP battery 200 or the 3P battery 202 with a corresponding screw hole 406, 506 at the top of the wall-mount bracket 400 and wall-mount bracket 500. In at least some embodiments, a plurality of mounting apertures 408, 508 can be provided on the wall-mount bracket 400 and wall-mount bracket 500 for securing the wall-mount bracket 400 and wall-mount bracket 500 to a mounting surface.

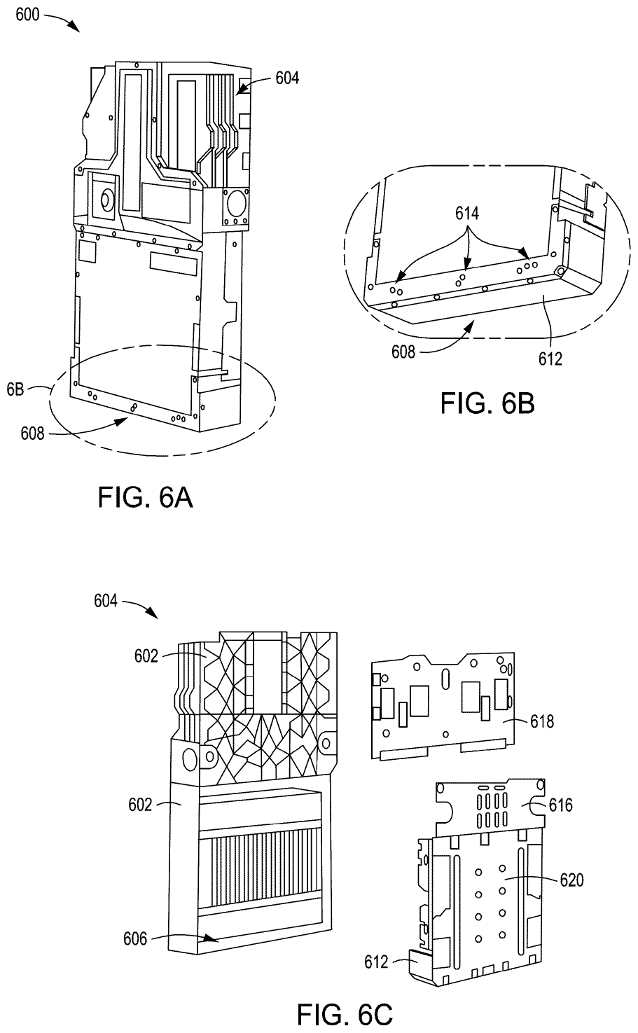

FIG. 6A is a perspective view of a chassis 600, FIG. 6B is the indicated area of detail of FIG. 6A, and FIG. 6C is an exploded view of the chassis 600 of FIG. 6A with parts separated, in accordance with at least some embodiments of the present disclosure.

For example, the chassis 600 comprises a plastic component 602. The plastic component 602 makes up a substantial portion of the chassis 600 and is configured to house one or more microinverters 604 (e.g., the microinverters 204) and one or more battery cells 606.

The chassis 600 comprises an outer metal barrier 608. The outer metal barrier 608 can be made from one or more suitable metals, e.g., steel, aluminum, etc. In at least some embodiments, the outer metal barrier 608 can be made from steel. The outer metal barrier 608 comprises a front portion 610 and a rear portion 612. Disposed along the front portion 610 of the outer metal barrier 608 can be one or more apertures 614 that are configured to allow excessive electrolyte to flow out of the chassis 600, e.g., in the event of thermal runaway.

The outer metal barrier 608 can be connected to the rear of a backing plate 616 (a metal backing plate). In at least some embodiments, the outer metal barrier 608 can be connected to a bottom rear of the backing plate 616 and/or the plastic component 602 via one or more screws, clips, nuts and bolts, etc. In at least some embodiments, the outer metal barrier 608 can connect to the backing plate 616 via one or more clips.

The backing plate 616 can be made from any material that is suitable for closing a compartment, which houses the one or more battery cells 606, of the plastic component 602. For example, the backing plate 616 can be made from metal. In at least some embodiments, the backing plate 616 is made from metal. In at least some embodiments, a backing plate extension 618 can be provided and configured to connect to the backing plate 616. The backing plate extension 618 can be configured to provide additional protection against thermal runaway. The backing plate extension 618 can be made from the same or different material as the backing plate 616. In at least some embodiments, the backing plate extension 618 is made from metal.

In at least some embodiments, an inner metal barrier 620 (e.g., a radiation barrier) is connected to the backing plate 616. The inner metal barrier 620 is configured to maintain heat within the chassis 600 in the event of thermal runaway. The inner metal barrier 620 can connect to the backing plate 616 via one or more screws, clips, nuts and bolts, etc. In at least some embodiments, the inner metal barrier 620 can connect to the backing plate 616 via one or more screws and to the outer metal barrier 608 via one or more clips. The inner metal barrier 620 can be made from one or more suitable metals, e.g., steel, aluminum, etc. In at least some embodiments, the inner metal barrier 620 can be made from steel.

While the foregoing is directed to embodiments of the present disclosure, other and further embodiments of the disclosure may be devised without departing from the basic scope thereof, and the scope thereof is determined by the claims that follow.

1. A storage system configured for use with an energy management system, comprising:
a battery;
a microinverter coupled to the battery; and
a chassis comprising a metal backing plate and an outer metal barrier connected to a the metal backing plate, the chassis configured to house the battery and the microinverter in an assembled configuration.

2. The storage system of claim 1, wherein the outer metal barrier is connected to a bottom rear of the metal backing plate.

3. The storage system of claim 2, further comprising a backing plate extension that connects to a top of the metal backing plate.

4. The storage system of claim 1, wherein the outer metal barrier comprises at least one aperture that is configured to allow excessive electrolyte to flow out of the chassis.

5. The storage system of claim 1, further comprising an inner metal barrier connected to the metal backing plate and to the outer metal barrier.

6. A storage system configured for use with an energy management system, comprising:
a battery;
a microinverter coupled to the battery; and
a chassis comprising a metal backing plate and an inner metal barrier connected to the metal backing plate, the chassis configured to house the battery and the microinverter in an assembled configuration.

7. The storage system of claim 6, further comprising a backing plate extension that connects to a top of the metal backing plate.

8. The storage system of claim 6, further comprising an outer metal barrier connected to a rear of the metal backing plate.

9. The storage system of claim 8, wherein the outer metal barrier is connected to a bottom rear of the metal backing plate.

10. The storage system of claim 8, wherein the outer metal barrier comprises at least one aperture that is configured to allow excessive electrolyte to flow out of the chassis.
